(19) United States
(12) Patent Application Publication
(10) Pub. No.: US 2019/0009750 A1
(43) Pub. Date: Jan. 10, 2019

(54) A VEHICLE WIPER UNIT

(71) Applicant: Ahmet Fikret KÖSE, Ankara (TR)

(72) Inventor: Ahmet Fikret KÖSE, Ankara (TR)

(21) Appl. No.: 15/748,911

(22) PCT Filed: Jul. 28, 2016
(86) PCT No.: PCT/TR2016/050245

§ 371 Date: Jan. 30, 2018

(30) Foreign Application Priority Data
Jul. 31, 2015 (TR) 2015/09525

(51) Int. Cl. B60S 1/36; B60S 1/34; B60S 1/38

(52) U.S. Cl. CPC B60S 1/365; B60S 1/3418; B60S 1/3849; B60S 1/3479

(57) ABSTRACT

This invention relates to a vehicle wiper unit (1) providing a safer and more comfortable drive to the drivers as a result of sweeping away with an increased sweeping area to weep accumulated rain and snow on the glass (4) of windshield and rear window (4) of any kind of land, air and marine vehicles. During sweeping wiper blade (5) makes a reciprocating motion on the window (4) in a linear direction by means of an actuator (3) situated within the vehicle wiper unit (1). Therefore a wider area is swept on vehicle window (4).

### TECHNICAL FIELD

This invention relates to a vehicle wiper unit providing a safer and more comfortable drive to the drivers as a result of sweeping away with an increased sweeping area to weep accumulated rain and snow on the glass of windshield and rear window of any kind of land, air and marine vehicles.

During sweeping wiper blade makes a reciprocating motion on the window in a linear direction by means of an actuator situated within the vehicle wiper unit. Therefore a wider area is swept on vehicle window.

### PRIOR ART

Today there are wiper units on windshield and rear windows of the land vehicles, air and marine vehicles. When it is required to clean the accumulated rain and snow on the window or just to clean the window then the wiper units fulfill this function. The wiper blade situated within the wiper units sweep and clean the central part of the relevant window by means of circular movements. Because the side parts are not swept, sight of the drivers becomes narrower. There are various studies in technical field related to this issue.

In a Chinese patent document No CN 201784584 as an improvement in technical field discloses cleaning the vehicle window by sweeping by means of a mechanical swivel arm. However window wiper blade with mechanical swivel arm has a motion capability of approximately ninety degrees and thus a wider area on a vehicle window could not be swept.

Another improvement in the technical field is French Patent Document No FR 2970925 and discloses an arm onto which wiperblade is mounted with telescopic structure and moving in a linear direction during sweeping action. In this document although the wiper blade sweeps a wider area, it could not be able to sweep the outside parts of elliptical shape formed as a result of its elliptical movement by means of the arm.

Another improvement in the technical field is U.S. Pat. No. 5,920,949 and discloses a wiper unit that sweeps a wider area on the window however it moves in a circular direction and it could not be able to sweep the upper parts of the window.

Another improvement in the technical field is a European Patent Document No EP 0696532and discloses a wiper unit. Although the wiper unit sweeps a wider area on the window by means of a jointed mechanism, it could not be able to sweep the upper parts of the window due to its elliptical movement.

As mentioned above in wiper units include within the technical field and widely used, we could not be able to talk about a wiper unit that sweeps a wider area with an increased sweeping area.

In addition to this a completely new wiper unit is designed in all of the abovementioned techniques. For this reason, it is required to make modifications in both wiper motor and mechanism and vehicle body designs. However in the new developed technique it is not required to make modifications in wiper motor and mechanism and vehicle body designs. Together with a modification made only within the wiper arm, the system could be used in both newly produced vehicles and also previously produced vehicles.

### SUMMARY OF THE INVENTION

The wiper unit developed according to the objects of this invention is shown in the attached figures.

Within these figures;

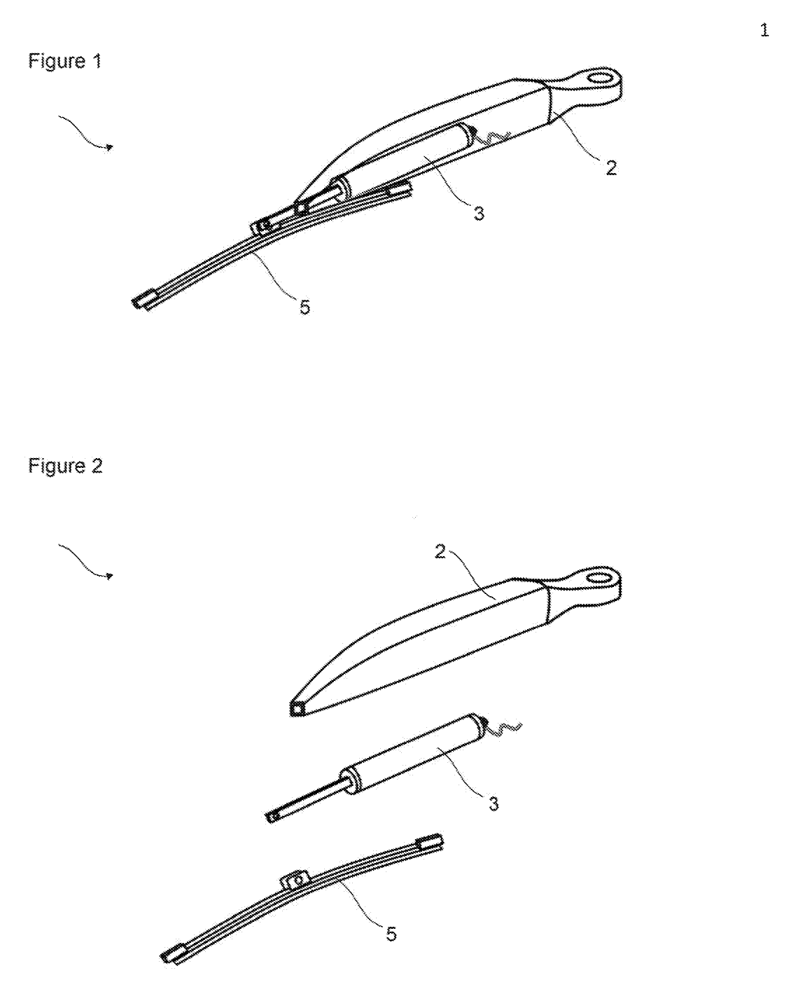

FIG. 1 is a view of a wiper unit according to the invention.

FIG. 2 is an explode view of a wiper unit according to the invention.

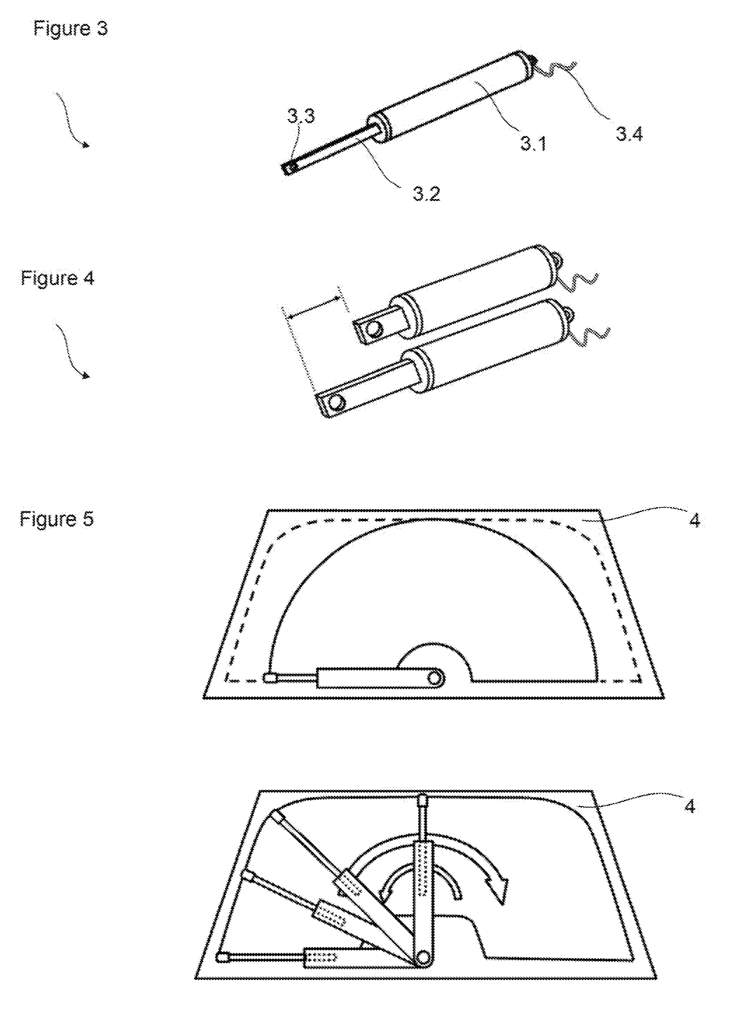

FIG. 3 is a view of a wiper unit actuator according to the invention.

FIG. 4 is a view of the position change of a wiper unit actuator according to the invention.

FIG. 5 is a view showing the movement directions and a wiper unit according to the invention mounted on a window.

The parts constituting the wiper unit according to the invention are numbered as the following in the attached drawings:
1. Wiper unit
2. Wiperarm
3. Actuator
   3.1 Body
   3.2 Mil
   3.3 Connection hole
   3.4 Power connection point
4. Window
5. Wiperblade

Wiper unit (1) according to the invention comprises;
at least a wiperarm (2)
a wiperblade (5) providing the sweeping and cleaning or the window (4) connected by means of an actuator (3) connected to wiperarm (2)
an actuator (3) having a shaft (3.2) moving wiperblade (5) on a window (4) connected to its end by causing its reciprocation motion to enter and exit from the body (3.1) by means of a microprocessor included within the internal part of the body (3.1) under wiperarm (2).

Microprocessor of the wiper unit (1) according to the invention gives command to the shaft (3.2) on a predetermined time and direction and moves the shaft (3.2). Therefore the wiperblade (5) connected to the shaft (3.2) sweeps and cleans a wider area on the window.

The actuator (3) of the per unit (1) according to the invention comprises:
a shaft (3.2) having a connection hole (3.3) providing the connection of wipe blade (5) to the end part by means of a connection member.

The actuator (3) of the wiper unit (1) according to the invention comprises:
a body (3.1) having a power connection point (3.4) providing the operation of the actuator (3) located within the rear part.

Within the wiper unit (1) according to the invention, during sweeping wiperblade (5) makes a reciprocating motion on the window (4) in a linear direction by means of an actuator (3) situated within the vehicle wiper unit (1). Therefore a wider area is swept on vehicle window (4).

Within the framework of this main concept, abovementioned wiper unit (1) according to the invention could be developed in various embodiments, the invention shall not be limited to the abovementioned embodiments, its main scope is as mentioned in the claims.

1.) A wiper unit (1) is characterized in that it comprises; at least a wiperarm (2), an actuator (3) having a shaft (3.2) moving wiperblade (5) on a window (4) connected to its end by causing its reciprocation motion to enter and exit from the body (3.1) by means of a microprocessor included within the internal part of the body (3.1) under wiperarm (2).

2.) A wiper unit (1) according to claim 1, characterized in that it comprises a shaft (3.2) having a connection hole (3.3) providing the connection of wiperblade (5) to the end by means of a connection member.

3.) A wiper unit (1) according to claim 1, characterized in that it comprises a body (3.1) having a power connection point (3.4) providing the operation of the actuator (3) located within the rear part.
